(19) United States
(12) Patent Application Publication
(10) Pub. No.: US 2003/0173912 A1
(43) Pub. Date: Sep. 18, 2003

(54) Circuit arrangement for igniting high pressure discharge lamps

(75) Inventors: Andreas Huber, Maisach (DE); Friedrich Witzani, Munchen (DE)

Correspondence Address: OSRAM SYLVANIA INC, 100 ENDICOTT STREET, DANVERS, MA, 01923, US

(73) Assignee: PATENT-TREUHAND-GESELLSCHAFT FUR ELEKTRISCHE GLUHL, Munchen (DE)

(21) Appl. No.: 10/385,841

(22) Filed: Mar. 12, 2003

(30) Foreign Application Priority Data
Mar. 12, 2002 (DE) 10210717.3

(51) Int. Cl. H05B 41/16

(52) U.S. Cl. 315/291; 315/261; 315/264; 315/276

(57) ABSTRACT

Circuit arrangement for igniting high-pressure discharge lamps by means of resonance ignition by a resonant circuit. According to the invention, the voltage for an auxiliary ignition electrode is provided by an ignition transformer into which the voltage is fed via an inductor of the resonant circuit. The inductor of the resonant circuit preferably forms the primary winding of the ignition transformer.

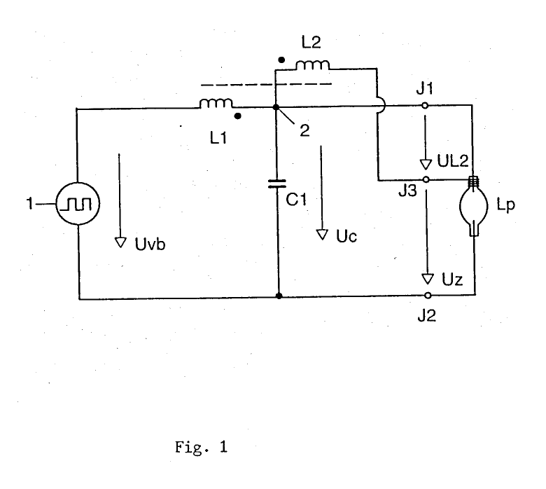

### TECHNICAL FIELD

The invention proceeds from a circuit arrangement in accordance with the preamble of claim 1. What is involved here, in particular, is a circuit arrangement for igniting high-pressure discharge lamps (also called lamp, below, for short). In addition, the invention relates to illuminating systems having an operating device and a high-pressure discharge lamp, for the purpose of supporting the ignition, the illuminating system having an auxiliary ignition electrode for which the abovenamed circuit arrangement provides a terminal in the operating device.

### BACKGROUND ART

Document WO 00/77826 (Van den Nieuwenhuizen) proposes a high-pressure discharge lamp having two electrodes, in the case of which a glass body that surrounds a supply lead to the electrode has a cavity. Laid around the glass body at the point at which the cavity is located is an auxiliary ignition electrode in the form of a wire loop that is connected in an electrically conducting fashion to the electrode on whose supply lead no cavity is located. The aim of this arrangement is to reduce the ignition voltage of the lamp. A dielectrically impeded discharge is excited in the cavity by the auxiliary ignition electrode. The UV radiation generated thereby produces ions in the discharge space of the lamp that support ignition of the lamp. The ignition voltage of the lamp, that is to say the voltage required for igniting the lamp, is admittedly reduced by the arrangement described, but the auxiliary ignition electrode now requires a high voltage that at least partially negates the said advantage.

Document WO 01/59811 attempts to solve this dilemma. It is proposed not to connect the auxiliary ignition electrode directly to an electrode of the lamp. Rather, the primary winding of a transformer is connected between the terminals of the lamp, and the auxiliary ignition electrode is connected to the voltage, stepped up by comparison with the primary winding, of a secondary winding. The outlay that must be made in the guise of the transformer is disadvantageous in this solution.

### DISCLOSURE OF THE INVENTION

It is an object of the present invention to provide a circuit arrangement for igniting high-pressure discharge lamps.

This object is achieved by a circuit arrangement having the following features:

an auxiliary ignition electrode terminal

a first and a second lamp terminal, and

a resonant circuit, comprising the series circuit of a resonance inductor and a resonance capacitor at whose connecting point there is formed a resonant circuit midpoint that is coupled to the first lamp terminal, while the second lamp terminal is coupled to the terminal of the resonance capacitor averted from the resonant circuit midpoint,

an ignition transformer with a primary and a secondary winding, the voltage that is present across the resonance inductor being fed into the primary winding, and

the auxiliary ignition electrode terminal is coupled to a first terminal of the secondary winding of the ignition transformer.

Furthermore the object is achieved by means of an illuminating system having the following features:

a circuit arrangement as claimed in claim 1,

a high-pressure discharge lamp whose electrodes are respectively coupled to the first and the second lamp terminal, and

an auxiliary ignition electrode that is mounted on the lamp and is coupled to the auxiliary ignition electrode terminal.

Particularly advantageous refinements are to be found in the dependent claims.

The lamps under discussion are AC voltage lamps that are fed from an AC voltage source that supplies an AC source voltage. Particularly with applications in projection engineering, the AC source voltage is preferably of square-wave form and is provided by means of a full bridge consisting of four electronic switches.

In the case of conventional lamps without the abovenamed cavity, a known pulsed ignition is mostly undertaken by means of a so-called ignition device that is connected between the AC voltage source and the lamp. In the case of lamps with a reduced ignition voltage, no pulsed ignition and therefore, no ignition device, are necessary owing to the abovenamed auxiliary ignition electrode and cavity. Rather, the ignition voltage is generated by the resonance of a resonant circuit composed of the series circuit of a resonance inductor and resonance capacitor. The resonant circuit is fed by the AC source voltage. A resonant circuit midpoint that is coupled to a first lamp terminal is formed at the connecting point between resonance inductor and resonance capacitor.

It is assumed below without limitation of generality that an abovementioned cavity present if required is located at the supply lead to the lamp electrode that is coupled to the first lamp terminal. The following embodiments with appropriately adapted terminal designations are valid for the other case.

The second lamp terminal is coupled to the terminal of the resonance capacitor that is averted from the resonant circuit midpoint. The lamp is therefore connected in parallel with the resonance capacitor. If the resonant circuit is excited with a resonant frequency, a voltage is formed across the lamp that suffices for igniting the lamp if a reduction in the ignition voltage is implemented by the abovenamed auxiliary ignition electrode and cavity. If the AC source voltage is of square wave form, it is not necessary for the fundamental of the AC source voltage to correspond to the resonant frequency of the resonant circuit; rather, harmonics of the AC source voltage can be utilized in order to excite the resonant circuit. The third, fifth or seventh harmonic is preferably utilized.

If a symmetrical design of the resonant circuit is desired, the resonance inductor can be split up into two component resonance inductors. One pole each of the AC source voltage is then connected via a component resonance inductor to the resonance capacitor, with which the lamp is connected in parallel.

It is now necessary, however, to provide at a terminal for the auxiliary ignition electrode a yet higher voltage than the ignition voltage present across the resonance capacitor in the case of resonance. This is achieved according to the invention by virtue of the fact that the voltage that is present across the resonance inductor is fed into the primary winding of an ignition transformer. At a secondary winding, the ignition transformer provides a voltage at the resonance inductor that is multiplied by a transformation ratio. A first terminal of the secondary winding is coupled to the terminal for the auxiliary ignition electrode. A second terminal of the secondary winding can be connected to different potentials of the circuit arrangement. It can be coupled to one of the two terminals of the resonance inductor or to the second lamp terminal. According to the invention, the transformation ratio is selected such that a voltage that is sufficient for generating UV radiation in the cavity is present between the first lamp terminal and the auxiliary electrode terminal during resonant operation of the resonant circuit.

The voltage that is set up between the auxiliary ignition electrode and the second lamp terminal is also important for selecting the coupling of the second terminal of the secondary inductor. A higher value for this voltage generates a high field strength in the lamp, thus providing support for the ignition of the lamp. According to the invention, the second terminal of the secondary winding is therefore preferably coupled to the resonant circuit midpoint.

According to the invention, in conjunction with the abovenamed field strength in the lamp, the winding sense of the ignition transformer is selected such that the voltage at the secondary winding is polarized such that it is added to and not subtracted from the voltage between the lamp terminals. That is to say, with reference to the second lamp terminal the voltage at the auxiliary ignition electrode terminal is higher than the voltage at the first lamp terminal.

As described above, according to the invention the voltage at the resonance inductor is fed into the primary winding of the ignition transformer. One component each is therefore generally required for the resonance inductor and the ignition transformer. According to the invention, the resonance inductor is used as primary winding of the ignition transformer in order to save a component. There is thus the advantage that no separate subassembly is required to provide the ignition transformer. The resonance inductor present in any case is extended only by one secondary winding.

In an illuminating system in which a lamp is connected at the lamp terminals of an operating device that includes the abovedescribed circuit arrangement, an auxiliary ignition electrode connected to the auxiliary ignition electrode terminal can be fitted at any desired point in the vicinity of the discharge vessel of the lamp. The ignition of the lamp is therefore supported by the abovenamed field strength. If the glass body of the lamp, which encloses a supply lead to an electrode, has a cavity, the auxiliary ignition electrode is preferably wound around the cavity in order to generate UV radiation.

### BEST MODE FOR CARRYING OUT THE INVENTION

A preferred exemplary embodiment of the invention is illustrated in the attached figure.

An AC source voltage Uvb is fed from an AC voltage source 1 into a resonant circuit comprising the series circuit of a resonance inductor L1 and a resonance capacitor C1. The resonant circuit midpoint 2 is formed at the connecting point between the resonance inductor L1 and the resonance capacitor C1. The resonant circuit midpoint 2 is connected to a first lamp terminal J1 at which a first electrode of a high-pressure discharge lamp Lp is connected. The terminal of the resonance capacitor C1 averted from the resonant circuit midpoint 2 is connected to a second lamp terminal J2 at which a second electrode of the high-pressure discharge lamp Lp is connected.

The resonance inductor L1 forms the primary winding of an ignition transformer. An inductor L2 forms the secondary winding of the ignition transformer. A first terminal of the inductor L2 is connected to the terminal J3 for an auxiliary ignition electrode. The auxiliary ignition electrode is wound around the supply lead to the first electrode of the lamp Lp and connected to terminal J3.

In order to ignite the lamp, the AC voltage source 1 outputs a square wave AC source voltage Uvb that has a harmonic in the vicinity of the resonant frequency of the resonant circuit. This produces across the resonance capacitor C1 an ignition voltage Uc that is fed to the lamp Lp via the terminals J1 and J2. In order for the ignition voltage Uc to suffice to ignite the lamp Lp, a voltage UL2 that exceeds the ignition voltage Uc must already be provided between the terminals J1 and J3. This is the case when a value greater than 1 is selected for the transformation ratio of the ignition transformer.

The voltage Uz is formed between the terminals J3 and J2. The higher the value of the voltage Uz, the less stringent are the requirements placed on the level of the ignition voltage. According to the invention, the winding sense is therefore selected for the ignition transformer in the way laid down in the figure by points at the inductors L1 and L2. Given the prescribed winding sense, Uz is equal to the sum of and not the difference between, the absolute values of the voltages Uc and UL2.

A dimensioning example for the preferred design of the invention may be specified below in accordance with the figure:

By selecting a value of 180 V for the AC source voltage Uvb, a value of 180 μH for the resonance inductor L1, a value of 2.2 nF for the resonance capacitor C1, and a value of 6 for the transformation ratio of the ignition transformer, a peak value of 4 kV results for the voltage UL2, given a frequency of approximately 51 kHz for the AC source voltage Uvb.

1. A circuit arrangement for igniting high-pressure discharge lamps, having the following features:
an auxiliary ignition electrode terminal
a first and a second lamp terminal, and
a resonant circuit, comprising the series circuit of a resonance inductor and a resonance capacitor at whose connecting point there is formed a resonant circuit midpoint that is coupled to the first lamp terminal, while the second lamp terminal is coupled to the terminal of the resonance capacitor averted from the resonant circuit midpoint,
characterized by the following features:
an ignition transformer with a primary and a secondary winding, the voltage that is present across the resonance inductor being fed into the primary winding, and
the auxiliary ignition electrode terminal is coupled to a first terminal of the secondary winding of the ignition transformer.

2. The circuit arrangement as claimed in claim 1, characterized in that a second terminal of the secondary winding is coupled to the resonant circuit midpoint.

3. The circuit arrangement as claimed in claim 1, characterized in that the primary winding is formed by the resonance inductor. 4. The circuit arrangement as claimed in claim 1, characterized in that the winding sense of the ignition transformer is selected such that with reference to the second lamp terminal the voltage at the auxiliary ignition electrode terminal is higher than the voltage at the first lamp terminal.

5. An illuminating system that has the following components:
a circuit arrangement as claimed in claim 1,
a high-pressure discharge lamp whose electrodes are respectively coupled to the first and the second lamp terminal, and
an auxiliary ignition electrode that is mounted on the lamp and is coupled to the auxiliary ignition electrode terminal

6. The illuminating system as claimed in claim 5, characterized in that at an electrode supply lead, the lamp has a cavity around which the auxiliary ignition electrode is at least partially wound.
